(19) United States
(12) Patent Application Publication
(10) Pub. No.: US 2009/0322680 A1
(43) Pub. Date: Dec. 31, 2009

(54) Radio frequency pointing device

(76) Inventor: Maurizio Sole Festa, Miami, FL (US)

Correspondence Address: RUBEN ALCOBA, ESQ., 3399 NW 72 AVENUE, SUITE211, MIAMI, FL, 33122, US

(21) Appl. No.: 12/215,844

(22) Filed: Jun. 30, 2008

(51) Int. Cl. G06F 3/033

(52) U.S. Cl. 345/160

(57) ABSTRACT

A radio frequency pointing device used for controlling a computer pointer/cursor. The device is a glove that has a pointing device mounted on the index finger of the glove, the device communicates with a computer via radio frequency transmissions. The device has ergonomically positioned switches and touch scroll sensors thereon. The device does not need a surface to control the movement of a computer pointer/cursor. A pair of gloves can be used simultaneously to provide the user of the gloves the ability to multitask by using two pointers.

### BACKGROUND

The present invention relates to the field of hand held computer controllers. More specifically, the present invention relates to radio frequency controllers that use the user's index finger to control the pointer of a computer and that do not require a physical surface to move the pointer.

The inventor of the present invention is a graphic designer. He realized that there was a need to have a radio frequency controller that would allow him to use his index fingers to design elements on a computer screen. He realized that if he created a glove in which the tip of his index finger could be used as a guide for a pointer of a computer that he would be able to manipulate pictures with greater ease than if he used other types of controllers. He further realized that the glove had to have ergonomic switches and touch scroll sensors. Being a designer, he then realized that if he could use both hands when creating designs that he would be able to better manipulate objects on a screen.

3D pointing devices are known in the art. Liberty et al., U.S. Pat. No. 7,239,301 is an example of a 3D pointing device that uses rotational sensors to control a cursor on a screen. The Liberty patent explains the general theory used in the present invention to control the movement of the pointing device. The Liberty patent does not focus on the method of placing the motion sensors of the device on the index finger. The Liberty patent also does not disclose the ergonomic benefits of placing the switches and the touch scroll sensors on specific points of a glove.

Quinn, U.S. Pat. No. 5,440,326, discloses a patent that uses a vertical gyroscope (motion sensor) to control the movements of a cursor on the display of a computer. The Quinn patent does not focus on the method of placing the motion sensors of the device on the index finger. The Quinn patent also does not disclose the ergonomic benefits of placing the switches and the touch scroll sensors on specific points of a glove.

An object of the present invention is to provide designers with a tool that will allow them to design directly on a computer screen using their index finger as a powerful design tool.

A further object of the present invention is to provide a glove that can control a pointer on a computer screen, the position of the pointer is manipulated by the movement of the user's index finger and having switches ergonomically positioned thereon.

Another object of the present invention is to provide a set of gloves that can control two pointers on a computer screen, the pointers are manipulated by the movement of the users index fingers from one location to another, and each glove has switches ergonomically positioned thereon.

Yet another object of the present invention is to allow the user of the invention, when using two gloves, to multitask.

A further object of the present invention is to allow the user, when using a 3D application or operating system, to control a pointer on a screen that represents a virtual 3 dimensional environment. Liberty patent also does not disclose the ergonomic benefits of placing the switches and the touch scroll sensors on specific points of a glove.

Quinn, U.S. Pat. No. 5,440,326, discloses a patent that uses a vertical gyroscope (motion sensor) to control the movements of a cursor on the display of a computer. The Quinn patent does not focus on the method of placing the motion sensors of the device on the index finger. The Quinn patent also does not disclose the ergonomic benefits of placing the switches and the touch scroll sensors on specific points of a glove.

An object of the present invention is to provide designers with a tool that will allow them to design directly on a computer screen using their index finger as the writing instrument.

A further object of the present invention is to provide a glove that can control a pointer on a computer screen, the pointer being manipulated by the movement of the user's index finger and having switches ergonomically positioned thereon.

Another object of the present invention is to provide a set of gloves that can control two pointers on a computer screen, the pointers are manipulated by the movement of the users index fingers from one location to another, and each glove has switches ergonomically positioned thereon.

Yet another object of the present invention is to allow the user of the invention, when using two gloves, to multitask.

A further object of the present invention is to allow the user, when using a 3D application or operating system, to control a pointer on a screen that represents a virtual 3 dimensional environment.

For the foregoing reasons, there is a need for a radio frequency pointing device that does not need a surface to control the positioning cursor on a computer interface.

### SUMMARY

The present invention, a radio frequency pointing device that does not need a surface to control the positioning cursor on a computer interface, the pointing device allows the user to control the movement of the cursor using the index finger of the user.

The device allows users to naturally write symbols on a screen without having to press on a physical surface to move the pointer. The radio frequency pointing device comprises of a first glove. The first glove has an upper and a lower surface, the first glove has a thumb sleeve, an index finger sleeve and a middle finger sleeve, the finger sleeves are cut so that the tips are open. A right core, the right core is attached to the upper surface of the index finger sleeve of the first glove at a location adjacent to the cut. The right core is a housing that houses a main logic circuit board, a board, logic components, motion sensors, and a radio frequency transceiver. A scrolling device attached to the side of the index finger sleeve of the first glove adjacent to the thumb sleeve, the scrolling device being connected to the right core via a scroll circuit. A first switch, the first switch being attached to the lower surface of the thumb sleeve of the first glove at a position adjacent to the cut and being connected to the right core via a first switch circuit. A second switch, the second switch being attached to the lower surface of the middle sleeve of the first glove at a position adjacent to the palm of the hand and being connected to the right core via a second switch circuit. And, a power source, the power source being attached to the first glove and connected via a first power source circuit to the right core.

The present invention can be a set of a radio frequency pointing devices that do not need a surface to control the positioning cursor on a computer interface. When using the set of radio frequency pointing devices, the user of the device has the ability to control two pointers on a computer screen simultaneously, thereby giving him the ability to multitask on one screen. In the field of graphic design, this is a tool that can save countless hours.

Further objects and advantages of the present invention will be apparent from the following description and the appended drawings, wherein preferred embodiments of the invention are clearly described and shown.

### DRAWINGS

These and other features, aspects, and advantages of the present invention will become better understood with regard to the following description, appended claims, and drawings where:

FIG. 1a shows a perspective view of the present invention showing how the device is used;

FIG. 1b shows a perspective of the present invention showing how a set of the devices is used simultaneously;

FIG. 2 shows finger path and vector components along axis Y and Z of the present invention;

FIG. 3 shows finger path and pointer movement from right to left on a computer screen;

FIG. 4 shows finger path and pointer movement in three directions on a computer screen;

FIG. 5 shows one embodiment of the present invention, this embodiment shows the motion sensors to be gyroscopic in nature;

FIG. 6 shows a top plan view of the first glove of the present invention;

FIG. 7 shows a bottom plan view of the first glove of the present invention;

FIG. 8a shows a perspective view of the first glove using another embodiment of the present invention, wherein two motion sensors axis system are being depicted on a computer screen;

FIG. 8b shows a perspective of how the embodiment of FIG. 8a would be used using two radio frequency devices on a computer screen using 3 dimensional view porting;

FIG. 9 shows a perspective of how motion is being mapped on and rendered on a computer screen wherein the user is moving his hand forward;

FIG. 10 shows a depiction of the two motion sensors within the core of the embodiment shown in FIG. 8a;

FIG. 11 shows a schematic view of the elements the present invention shown on each glove when using one motion sensor within one core;

FIG. 12 shows a flow chart showing how a cursor control signal is generated using the embodiment of FIG. 11.

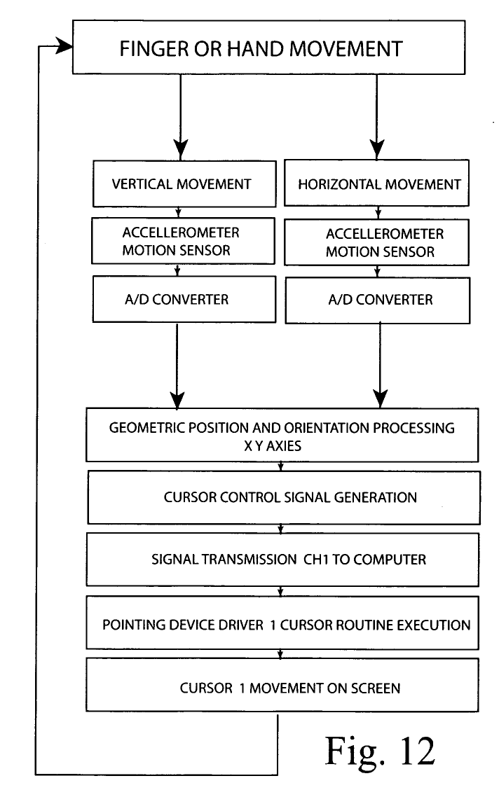

FIG. 13 shows a flow chart showing how a cursor control signal is generated using the embodiment of FIG. 11 when a user is using two gloves;

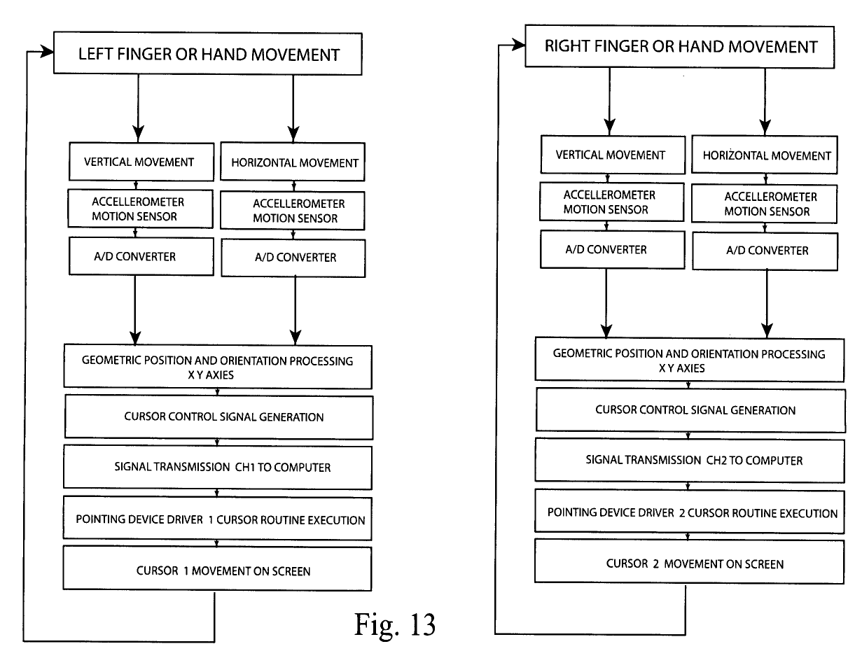

FIG. 14 shows a schematic view of the elements the present invention shown on each glove when using two motion sensors within one core;

FIG. 15 shows a flow chart showing how a cursor control signal is generated using the embodiment of FIG. 14; and

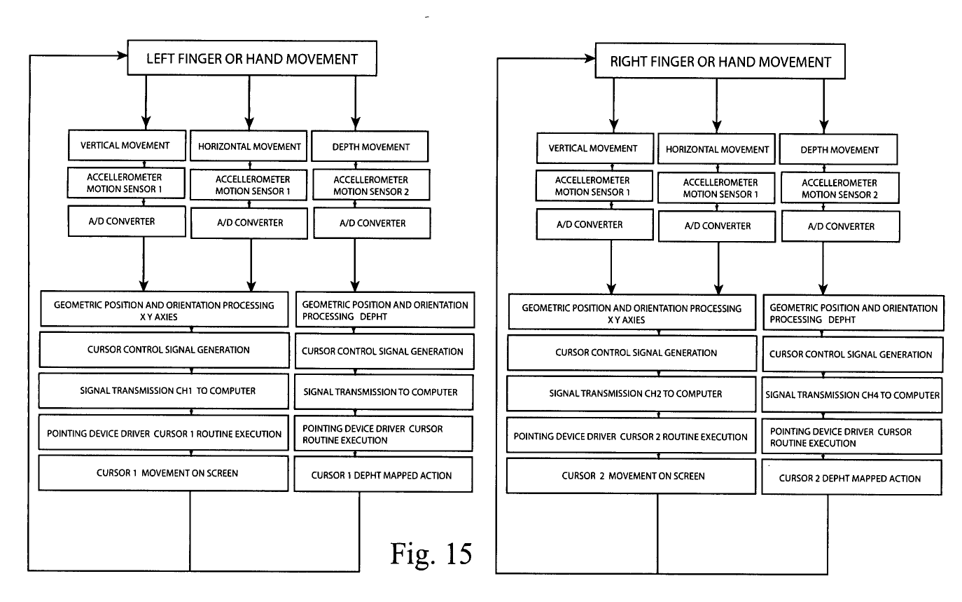

FIG. 16 shows a flow chart showing how a cursor control signal is generated using the embodiment of FIG. 14 when a user is using two gloves.

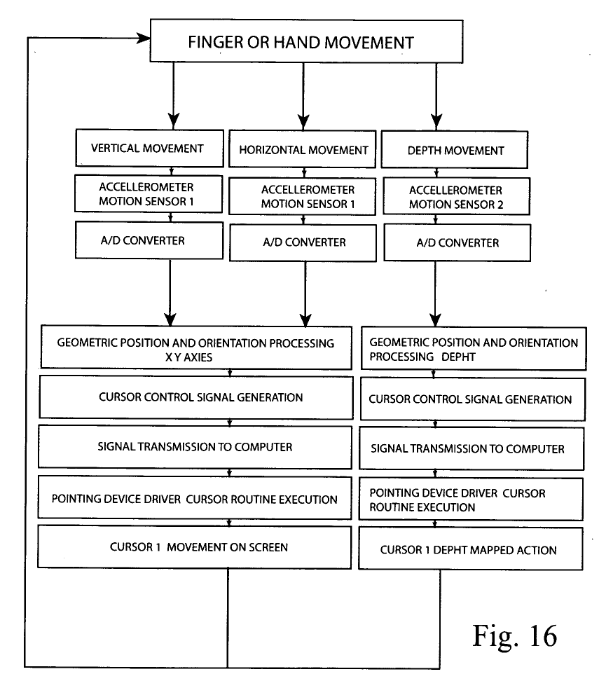

### DESCRIPTION

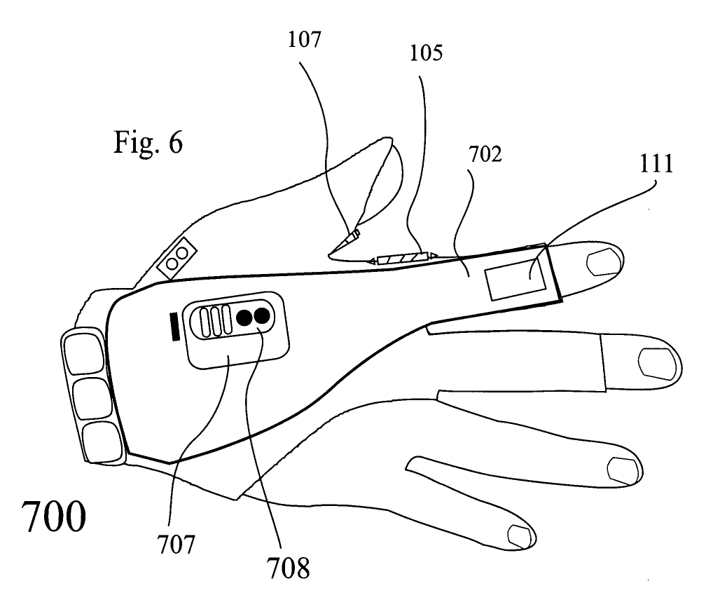

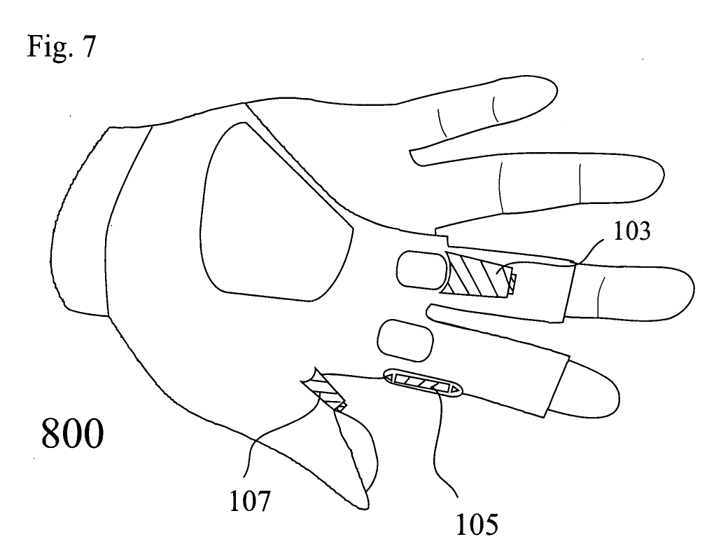

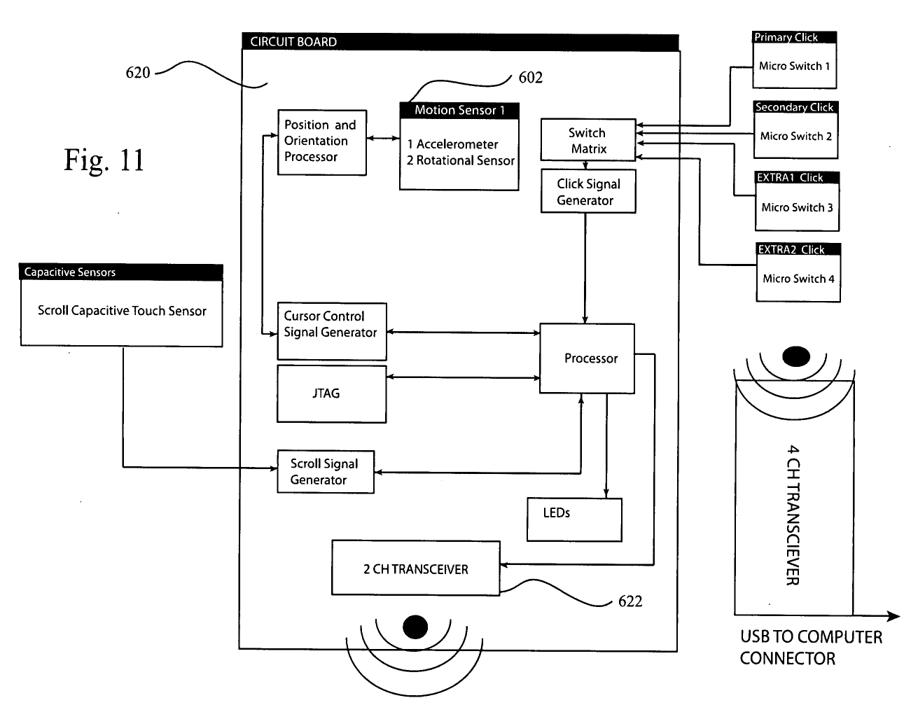

As seen in FIGS. 6-7, and 11, a radio frequency pointing device 100A-100B that does not need a surface to control the positioning of a cursor on a computer interface, comprises a first glove 100A, the first glove 100A has an upper and a lower surface, the first glove 100A has a thumb sleeve 100, an index finger sleeve 12 and a middle finger sleeve 14, the finger sleeves are cut so that the tips are open. A right core 111, the right core 111 is attached to the upper surface of the index finger sleeve 12 of the first glove 100A at a location adjacent to the cut, the right core 111 comprises of a housing, the housing houses a main logic circuit board 620, logic components (not numbered and all logic components are installed on the circuit board and seen in FIG. 11), a motion sensor 602, and a radio multi-channel frequency transceiver 622. A scrolling device 105 attached to the side of the index finger sleeve 12 of the first glove 100A adjacent to the thumb sleeve 10, the scrolling device 105 is connected to the right core 111 via a scroll circuit. A first switch 107, the first switch 107 is attached to the lower surface of the thumb sleeve 10 of the first glove 100A at a position adjacent to the cut and is connected to the right core 111 via a first switch circuit. A second switch 103, the second switch 103 is attached to the lower surface of the middle sleeve 16 of the first glove 100A at a position adjacent to the palm of the hand and is connected to the right core 111 via a second switch circuit. And, a power source 707, the power source 707 is attached to the first glove 100A and is connected via a first power source circuit to the right core 111.

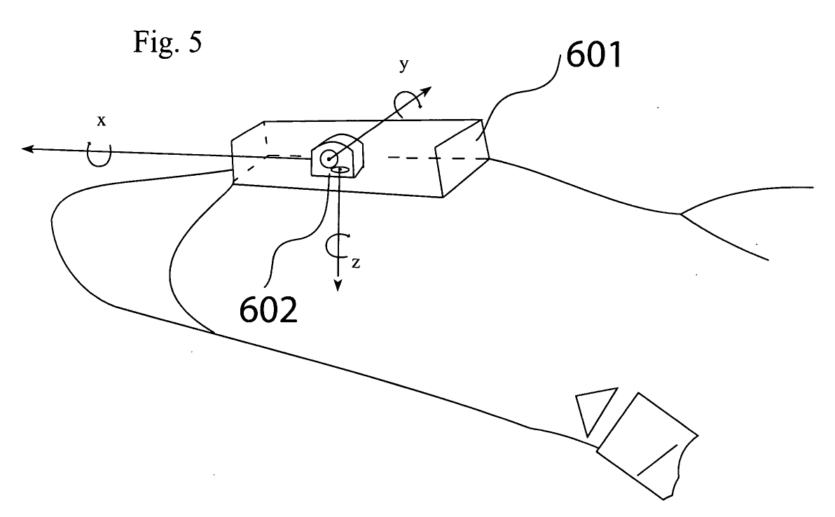

As seen in FIG. 5 and 11, the motion sensor 602 comprises of two rotational sensors attached to an accelerometer. The rotational sensors work with the accelerometer to generate an output signal. In the present invention, the rotational sensors are positioned so that they are ninety degrees from each other, forming a first motion sensor axis system, allowing the rotational sensors to capture changes in inertial status of the core. The signals are processed through the accelerometer and sent to a processor that defines a position and orientation calculation that in turn is sent to a central processor as a digital result, the digital result is then sent to computer via transceivers.

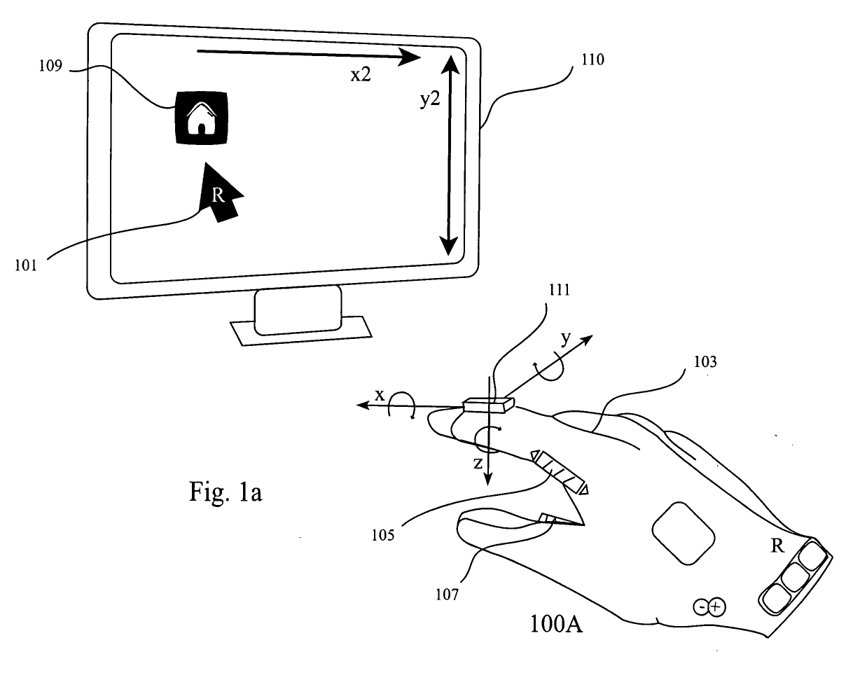

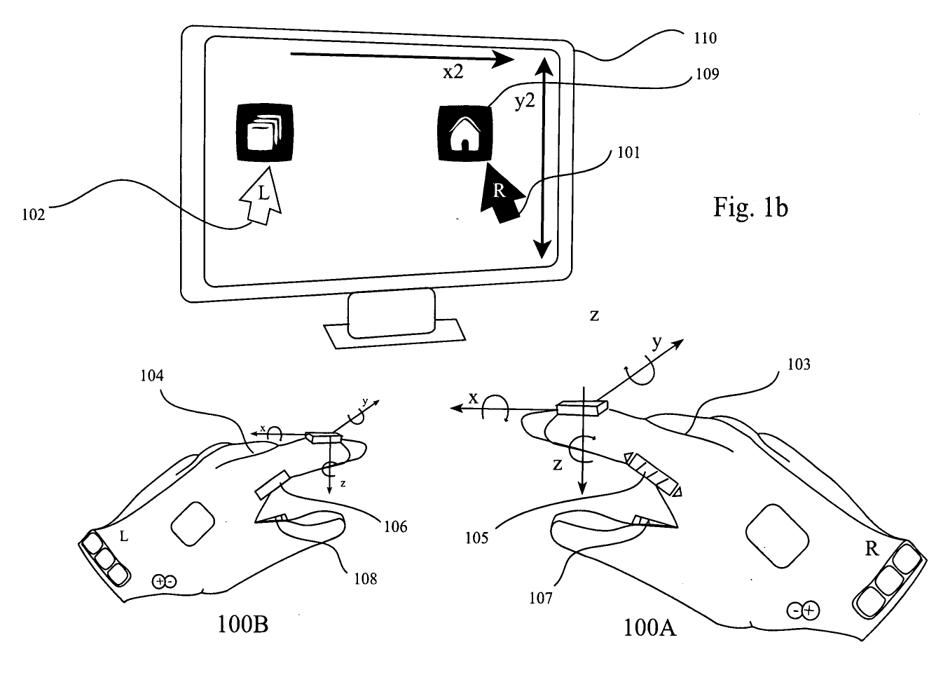

As seen in FIG. 1b, in another embodiment of the present invention, radio frequency pointing device of claim 1, further comprises a second glove 100B, the second glove 100B has an upper and a lower surface, the second glove 100B has a thumb sleeve 20, an index finger sleeve 22 and a middle finger sleeve 24, the fingers' sleeves are cut so that the tips are open. A left core 112, the left core 112 is attached to the upper surface of the index finger sleeve 20 of the second glove 100B at a location adjacent to the cut, the left core 112 comprises of a housing. The housing houses a main logic circuit board, a board, logic components, motion sensors, and a radio frequency transceiver. An on and off switch 106 is attached to the side of the index finger sleeve of the second glove 100B adjacent to the thumb sleeve 20. The on and off switch 106 is connected to the left core 112 via an on and off switch circuit. A third switch 108, the third switch 108 is attached to the lower surface of the thumb sleeve 20 of the second glove 100b at a position adjacent to the cut and being connected to the left core 112 via a third switch circuit. A fourth switch 104, the fourth switch 104 is attached to the lower surface of the middle sleeve 22 of the second glove 100B at a position adjacent to the palm of the hand and is connected to the left core 112 via a fourth switch circuit. And a second power source (not seen in the picture), the second power source is attached to the second glove 100B and is connected via a second power source circuit to the left core 112.

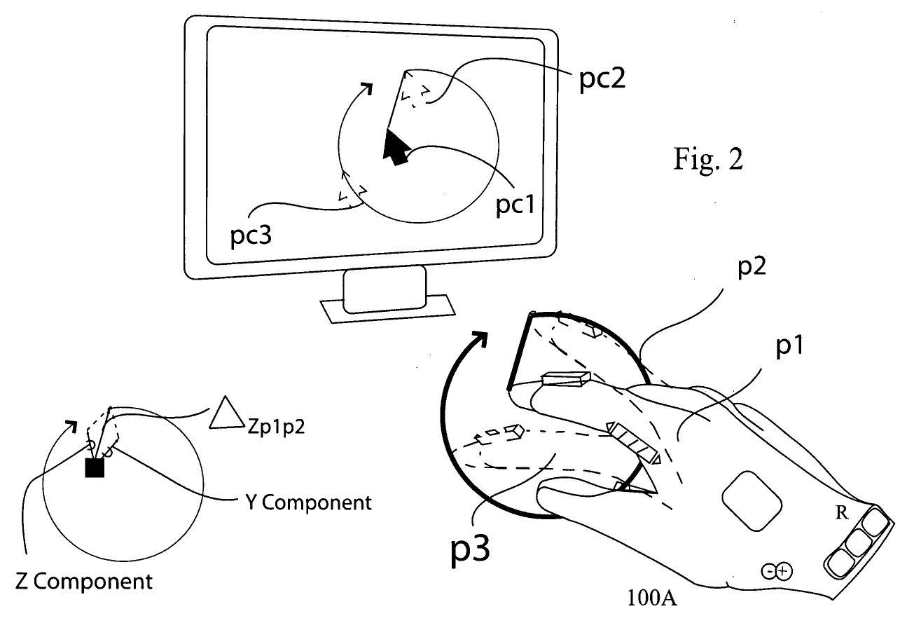

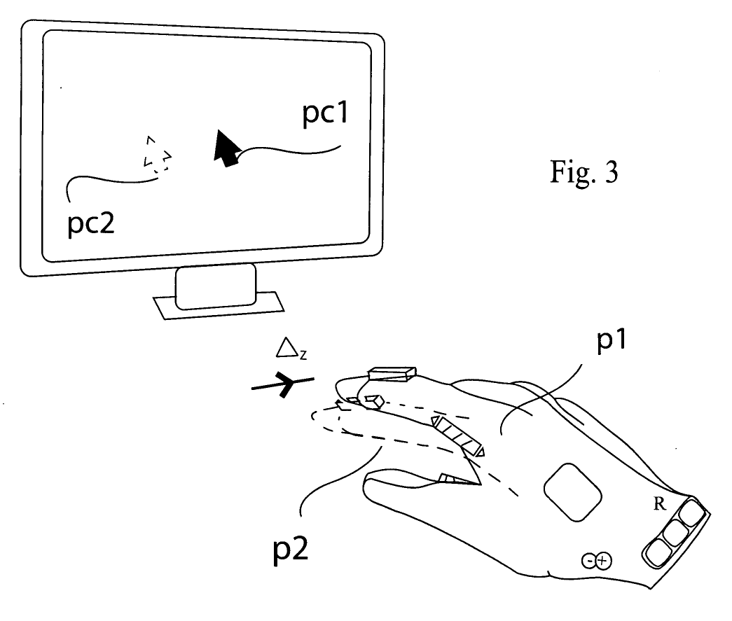

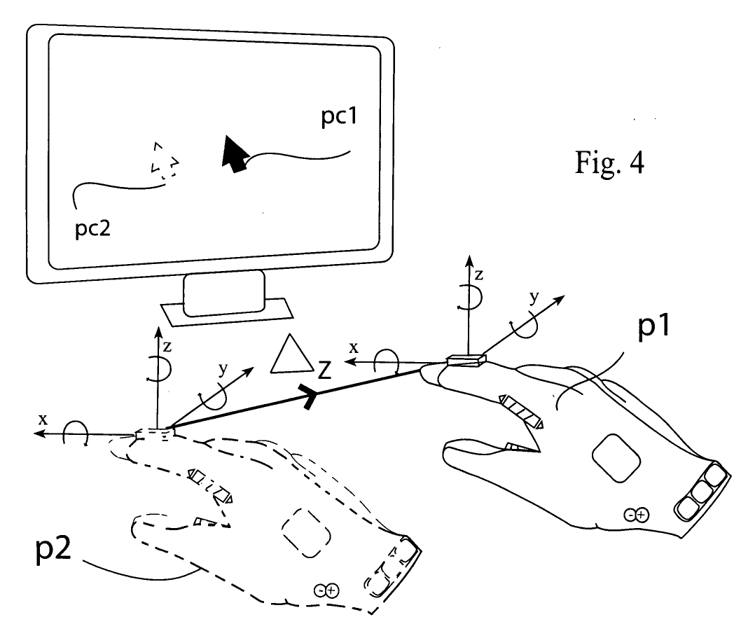

As seen in FIGS. 1a-5, in the preferred embodiment of the present invention, the motion sensors are gyroscopic and are positioned within the cores 111-112 so that when a user moves his index finger in an x, y or z direction, the logic components of the gloves 100A-B can transmit a signal to a computer interface instructing the computer to move a pointer in a certain direction that corresponds to the users movement of the user's index finger.

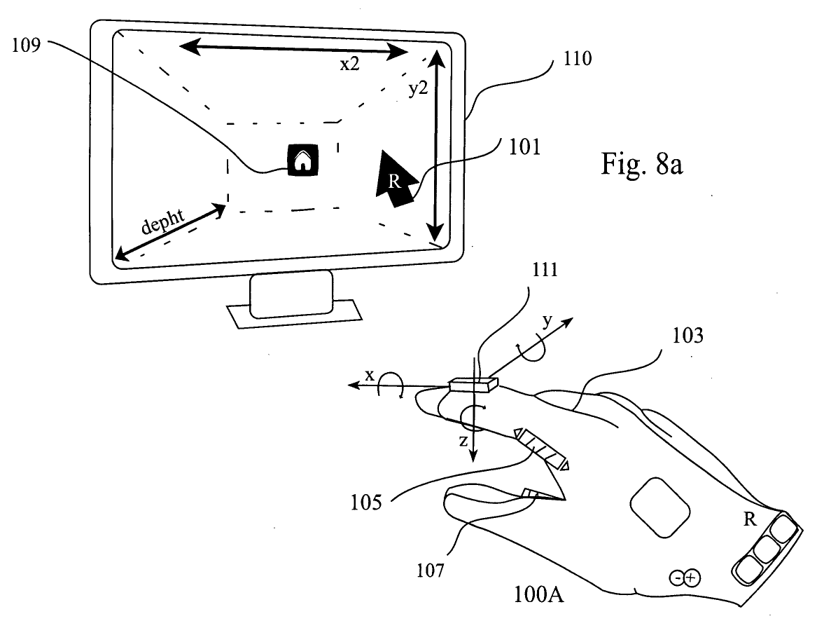

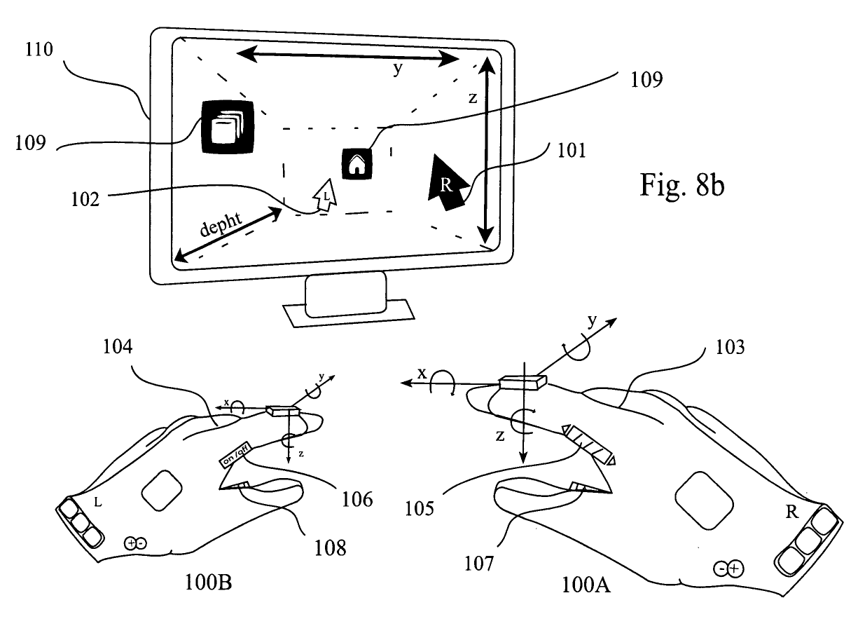

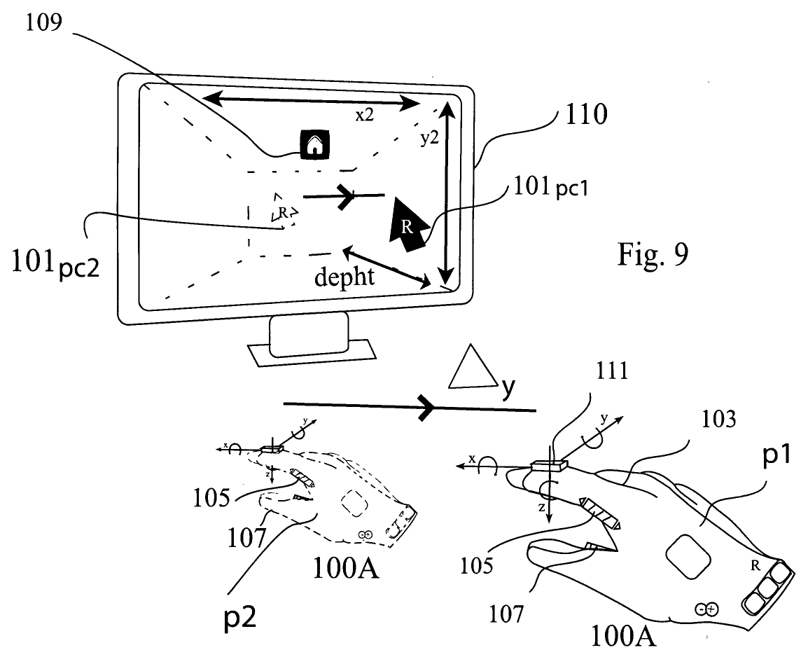

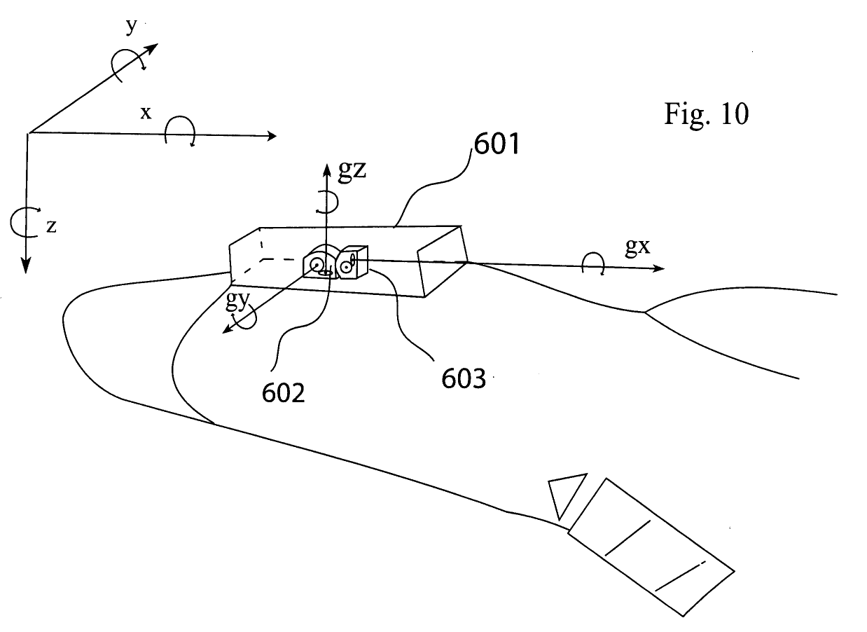

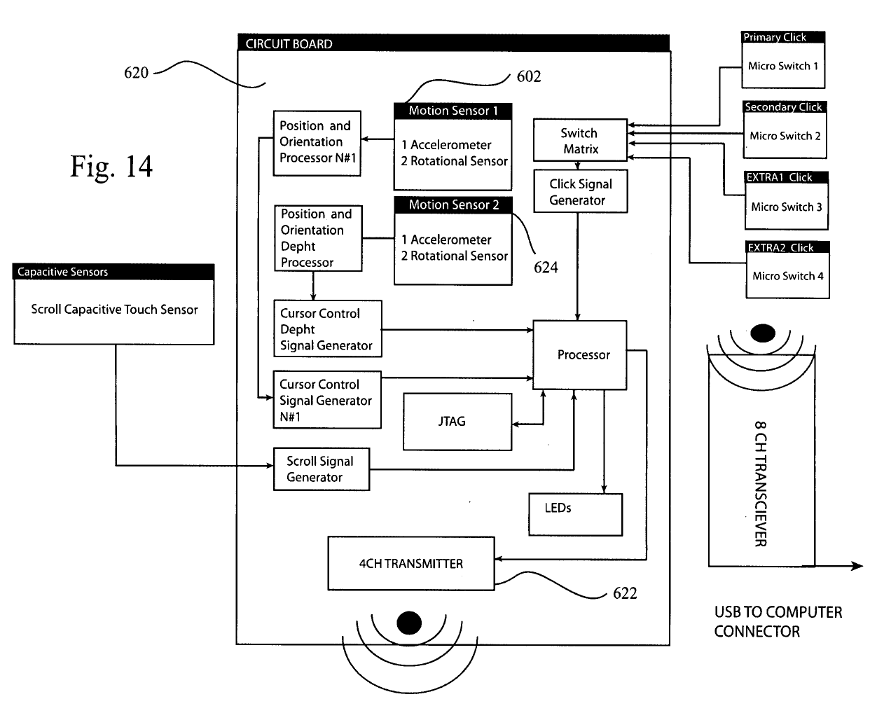

As seen in FIGS. 8a-10, and 14, in another embodiment of the invention, A second motion sensor 624 will be housed in the core 601 so that the second motion sensor's axis system is 90 degrees from the first motion sensor axis system. The second motion sensor 624 comprises of two rotational sensors attached to an accelerometer. The rotational sensors work with the accelerometer to generate a second output signal. The rotational sensors are positioned so that they are ninety degrees from each other, forming a second motion sensor axis system. The second motion sensor sends a second output signal to the processor defining a position and orientation calculation that in turn is sent to a central processor as a digital result, the digital result is then sent to computer via transceivers. By sending the second motion sensors 624 signal to the computer, the present invention is able to depict movement of the pointing device in a third dimension within the screen of computer or any other devices' driver mapped action.

As seen in FIG. 6, in another embodiment of the present invention, the power source 708 has the capacity to be charged.

An advantage of the present invention is that it provides designers with a tool that allows them to design directly on a computer screen using their index finger as a powerful design tool.

A further advantage of the present invention is that it provides a glove that controls a pointer on a computer screen, the position of the pointer is manipulated by the movement of the user's index finger and the glove has switches that are ergonomically positioned thereon.

Another advantage of the present invention is that it provides a set of gloves that controls two pointers on a computer screen, the pointers are manipulated by the movement of the users index fingers from one location to another, and each glove has switches ergonomically positioned thereon.

Yet another advantage of the present invention is that it allows the user of the invention, when using two gloves, to multitask.

The above is a detailed description of particular preferred embodiments of the invention. Those with skill in the art should, in light of the present disclosure, appreciate that obvious modifications of the embodiments disclosed herein can be made without departing from the spirit and scope of the invention. All of the embodiments disclosed and claimed herein can be made and executed without undue experimentation in light of the present disclosure. The full scope of the invention is set out in the claims that follow and their equivalents.

1. A radio frequency pointing device that does not need a surface to control the positioning of a cursor on a computer interface, comprising:
a first glove, the first glove has an upper and a lower surface, the first glove has a thumb sleeve, an index finger sleeve and a middle finger sleeve, the finger sleeves are cut so that the tips are open;
a right core, the right core attaches to the upper surface of the index finger sleeve of the first glove at a location adjacent to the cut, the right core comprises of a housing, the housing houses a main logic circuit board, logic components, a motion sensor, and a radio multi-channel frequency transceiver;
a scrolling device attaches to the side of the index finger sleeve of the first glove adjacent to the thumb sleeve, the scrolling device being connected to the right core via a scroll circuit;
a first switch, the first switch attaches to the lower surface of the thumb sleeve of the first glove at a position adjacent to the cut and being connected to the right core via a first switch circuit;
a second switch, the second switch attaches to the lower surface of the middle sleeve of the first glove at a position adjacent to the palm of the hand and is connected to the right core via a second switch circuit; and
a power source, the power source attaches to the first glove and is connected via a first power source circuit to the right core.

2. The radio frequency pointing device of claim 1, wherein the motion sensor comprises of two rotational sensors attached to an accelerometer, the rotational sensors work with the accelerometer to generate an output signal, the rotational sensors are positioned so that they are ninety degrees from each other, thereby forming a first motion sensor axis system.

3. The radio frequency pointing device of claim 2, further comprising:
a second glove, the second glove has an upper and a lower surface, the second glove has a thumb sleeve, an index finger sleeve and a middle finger sleeve, the fingers' sleeves are cut so that the tips are open;
a left core, the left core attaches to the upper surface of the index finger sleeve of the second glove at a location adjacent to the cut, the left core comprises of a housing, the housing houses a main logic circuit board, logic components, motion sensors, and a radio frequency transceiver;
an on and off switch attaches to the side of the index finger sleeve of the second glove adjacent to the thumb sleeve, the on and off switch is connected to the left core via an on and off switch circuit;
a third switch, the third switch attaches to the lower surface of the thumb sleeve of the second glove at a position adjacent to the cut and is connected to the left core via a third switch circuit;
a fourth switch, the fourth switch attaches to the lower surface of the middle sleeve of the second glove at a position adjacent to the palm of the hand and is connected to the left core via a fourth switch circuit; and
a second power source, the second power source attaches to the second glove and is connected via a second power source circuit to the left core.

4. The radio frequency pointing device of claim 3, wherein the motion sensors are gyroscopic and are positioned within the cores so that when a user moves his index finger in an x, y or z direction, the logic components of the gloves can transmit a signal to a computer interface instructing the computer to move a pointer in a certain direction that corresponds to the users movement of the user's index finger.

5. The radio frequency device of claim 4, wherein the power source have the capacity to be charged.

6. The radio frequency pointing device of claim 2, wherein the motion sensors are gyroscopic and are positioned within the cores so that when a user moves his index finger in an x, y or z direction, the logic components of the gloves can transmit a signal to a computer interface instructing the computer to move a pointer in a certain direction that corresponds to the users movement of the user's index finger.

7. The radio frequency device of claim 6, wherein the power source have the capacity to be charged.

8. The radio frequency device of claim 2, further comprising a second motion sensor, the second motion sensor comprises of two rotational sensors attached to an accelerometer, the rotational sensors work with the accelerometer to generate an second output signal, the rotational sensors are positioned so that they are ninety degrees from each other, thereby forming a second motion sensor axis system, the second motion sensor is housed within the core so that the second motion sensor axis system is 90 degrees from the first motion sensor axis system.

9. The radio frequency pointing device of claim 8, further comprising:
a second glove, the second glove has an upper and a lower surface, the second glove has a thumb sleeve, an index finger sleeve and a middle finger sleeve, the fingers' sleeves are cut so that the tips are open;
a left core, the left core attaches to the upper surface of the index finger sleeve of the second glove at a location adjacent to the cut, the left core comprises of a housing, the housing houses a main logic circuit board, logic components, motion sensors, and a radio frequency transceiver;
an on and off switch attaches to the side of the index finger sleeve of the second glove adjacent to the thumb sleeve, the on and off switch is connected to the left core via an on and off switch circuit;
a third switch, the third switch attaches to the lower surface of the thumb sleeve of the second glove at a position adjacent to the cut and is connected to the left core via a third switch circuit;
a fourth switch, the fourth switch attaches to the lower surface of the middle sleeve of the second glove at a position adjacent to the palm of the hand and is connected to the left core via a fourth switch circuit; and
a second power source, the second power source attaches to the second glove and is connected via a second power source circuit to the left core.

10. The radio frequency pointing device of claim 9, wherein the motion sensors are gyroscopic and are positioned within the cores so that when a user moves his index finger in an x, y or z direction, the logic components of the gloves can transmit a signal to a computer interface instructing the computer to move a pointer in a certain direction that corresponds to the users movement of the user's index finger.

11. The radio frequency device of claim 10, wherein the power source have the capacity to be charged.

12. The radio frequency pointing device of claim 8, wherein the motion sensors are gyroscopic and are positioned within the cores so that when a user moves his index finger in an x, y or z direction, the logic components of the gloves can transmit a signal to a computer interface instructing the computer to move a pointer in a certain direction that corresponds to the users movement of the user's index finger.

13. The radio frequency device of claim 12, wherein the power source have the capacity to be charged.
